(19) United States
(12) Patent Application Publication
(10) Pub. No.: US 2022/0343302 A1
(43) Pub. Date: Oct. 27, 2022

(54) INTER WALLET TRANSACTIONS

(71) Applicant: Visa International Service Association, San Francisco, CA (US)

(72) Inventors: Rahul Singhal, Whitefield, Bangalore (IN); Animesh Kumar, Krishnarajapuram Hobli, Bangalore (IN)

(21) Appl. No.: 17/763,673

(22) PCT Filed: Oct. 21, 2019
(86) PCT No.: PCT/US19/57219

§ 371 Date: Mar. 25, 2022

(51) Int. Cl. G06Q 20/10; G06Q 20/36; G06Q 20/38; G06Q 20/40

(52) U.S. Cl. CPC G06Q 20/10; G06Q 20/3674; G06Q 20/385; G06Q 20/4016

(57) ABSTRACT

The present disclosure relates generally to electronic transactions, and more specifically, to perform inter wallet transactions. A directory server may act as a network between a plurality of wallets. In some non-limiting embodiments or aspects, the directory server receives a request message from a first wallet server for initiating a transaction from a first wallet user to a second wallet user associated with a second wallet server. In some non-limiting embodiments or aspects, the directory server sends one or more details among a plurality of details associated with the second wallet server and the second wallet user to the first wallet server in response to the request message.

### BACKGROUND

### 1. Technical Field

The present disclosure relates generally to electronic transactions, and more specifically, to perform inter wallet transactions.

### 2. Technical Considerations

Currently, electronic wallet (e-wallet) or digital wallet or mobile wallet transactions are increasing as they provide simpler means for making transactions. E-wallets have many benefits over conventional transaction techniques including card payments, cash payments, bank transfers, etc. As electronic devices have evolved immensely, the e-wallets have benefitted the technological advancements. E-wallets are applications installed in electronic devices and payment from an e-wallet can be made using Bluetooth®, near-field communication (NFC), and the like.

Just like a typical transaction where a user making a transaction is associated with an issuer bank and a merchant is associated with an acquirer bank, each e-wallet user is associated with a bank. However, an e-wallet can store multiple issuer bank details for a user. For the abovementioned reasons, e-wallets are preferred over conventional payment techniques. Existing e-wallets do not provide an option to transact with other e-wallets, for example, transferring money from one wallet to another wallet. Also, there does not exist a framework for enabling transactions between e-wallets. Thus, there is a need to enable transactions between e-wallets and create a framework for such inter wallet transactions.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

In some non-limiting embodiments or aspects, provided is a computer-implemented method, comprising: receiving, by a directory server, a request message from a first wallet server for initiating a transaction from a first wallet user associated with the first wallet server to a second wallet user associated with a second wallet server, wherein the first wallet user, the first wallet server, the second wallet user, and the second wallet server are registered with the directory server, and a plurality of details associated with the first and the second wallet users and the first and the second wallet servers is stored in a database associated with the directory server; sending, by the directory server to the first wallet server, one or more details among the plurality of details associated with the second wallet server and the second wallet user in response to the request message, wherein the first wallet server generates a transaction message comprising at least the one or more details; receiving, by the directory server, the transaction message and appending transaction details; and sending, by the directory server, the transaction message to the second wallet server for completing the transaction between the first wallet server and the second wallet server.

In some non-limiting embodiments or aspects, the plurality of details is stored in the database in a tokenized manner after successful registration of the first and the second wallet users and the first and the second wallet servers with the directory server. In some non-limiting embodiments or aspects, the plurality of details comprises at least one of the following: a plurality of first wallet server identities, a plurality of second wallet server identities, a plurality of first wallet user aliases, a plurality of second wallet user aliases, a first wallet server name, a second wallet server name, a first wallet username, a second wallet username, first wallet user contact details, second wallet user contact details, or any combination thereof. In some non-limiting embodiments or aspects, the one or more details comprise at least one of a second wallet server identification and a second wallet user alias, wherein at least the second wallet server identification is included in the transaction message. In some non-limiting embodiments or aspects, the one or more details are tokenized before sending to the first wallet server.

In some non-limiting embodiments or aspects, the method further comprises verifying compliance of the transaction message with one or more business rules. In some non-limiting embodiments or aspects, the one or more business rules comprise validating the transaction message for Anti-Money Laundering (AML) compliance based at least partially on verifying historical data associated with the first and the second wallet users. In some non-limiting embodiments or aspects, the one or more business rules comprise validating the transaction message for Know Your Customer (KYC) compliance based at least partially on verifying at least information associated with the first and the second wallet users and the first and the second wallet servers, and the plurality of details. In some non-limiting embodiments or aspects, the one or more business rules are used to determine a chargeback and representment for the transaction.

In some non-limiting embodiments or aspects, the transaction details comprise at least one of the following: a type of transaction, a first wallet server identification, a first wallet server name, a second wallet server identification, a second wallet server name, a first wallet user alias, a second wallet user alias, transaction amount, transaction date, transaction time, transaction location, transaction currency, or any combination thereof. In some non-limiting embodiments or aspects, the transaction message is generated according to ISO 8583 standard and ISO 20022 standard.

In some non-limiting embodiments or aspects, provided is a directory server, comprising: one or more processors; and one or more computer-readable media, communicatively coupled to the one or more processors and storing instructions, which upon execution causes the processor to: receive a request message from a first wallet server for initiating a transaction from a first wallet user associated with the first wallet server to a second wallet user associated with a second wallet server, wherein the first wallet user, the first wallet server, the second wallet user, and the second wallet server are registered with the directory server, and a plurality of details associated with the first and the second wallet users and the first and the second wallet servers is stored in a database associated with the directory server; send, to the first wallet server, one or more details among the plurality of details associated with the second wallet server and the second wallet user in response to the request message, wherein the first wallet server generates a transaction message comprising at least the one or more details; receive the transaction message and appending transaction details; and send the transaction message to the second wallet server for completing the transaction between the first wallet server and the second wallet server.

In some non-limiting embodiments or aspects, the one or more processors are configured to store the plurality of details in the database in a tokenized manner after successful registration of the first and the second wallet users and the first and the second wallet servers with the directory server. In some non-limiting embodiments or aspects, the one or more processors are configured to verify compliance of the transaction message with one or more business rules for at least one of the following: validating the transaction message for Anti-Money Laundering (AML) compliance based at least on verifying historical data associated with the first and the second wallet users; validating the transaction message for Know Your Customer (KYC) compliance based at least on verifying at least information associated with the first and the second wallet users and the first and the second wallet servers, and the plurality of details; or any combination thereof. In some non-limiting embodiments or aspects, the one or more processors use the one or more business rules to determine a chargeback and representment for the transaction.

In some non-limiting embodiments or aspects, provided is a computer-implemented method comprising: receiving, by a directory server, a plurality of registration details related to a plurality of wallet servers and respective wallet users for registering with the directory server; authenticating, by the directory server, the plurality of registration details of the plurality of wallet servers and respective wallet users based on a plurality of parameters; creating, by the directory server, an identity for each wallet server and an alias for each respective wallet user; and tokenizing, by the directory server, the plurality of registration details for storing the plurality of details and a plurality of tokens corresponding to the plurality of details in a database associated with the directory server, wherein a first wallet server initiated a transaction between a first wallet user associated with the first wallet server and a second wallet user associated with a second wallet server, wherein the first wallet server generates a transaction message comprising at least one or more details associated with the first and the second wallet users and the first and the second wallet servers are stored in a database associated with the directory server, wherein the directory server receives the transaction message and appends transaction details in the transaction message and sends the transaction message to the second wallet server for completing a wallet-to-wallet transfer.

In some non-limiting embodiments or aspects, the plurality of registration details comprises at least one of the following: name and address of the plurality of wallet servers, name and address of the respective wallet users, Know Your Customer (KYC) details associated with the wallet customer, currency enabled in the plurality of wallet servers, currency preferred by the wallet users, or any combination thereof. In some non-limiting embodiments or aspects, the plurality of parameters comprises at least one of the following: a risk score associated with the plurality of wallet servers and/or the wallet users, transactions patterns associated with the wallet servers and/or the wallet users, chargeback patterns associated with the wallet users, representment history associated with the wallet users, transaction success rate associated with the wallet servers, or any combination thereof.

In some non-limiting embodiments or aspects, the method further comprises determining Anti-Money Laundering (AML) activity of at least one of the plurality of wallet servers or respective wallet users based on the plurality of parameters and one or more business rules. In some non-limiting embodiments or aspects, the method further comprises at least one of the following: validating the transaction message for Anti-Money Laundering (AML) compliance based at least on verifying historical data associated with the first and the second wallet users; validating the transaction message for Know Your Customer (KYC) compliance based at least on verifying information associated with the first and the second wallet users and the first and the second wallet servers, and the plurality of details; or any combination thereof.

Further non-limiting embodiments or aspects are set forth in the following numbered clauses.

Clause 1: A computer-implemented method, comprising: receiving, by a directory server, a request message from a first wallet server for initiating a transaction from a first wallet user associated with the first wallet server to a second wallet user associated with a second wallet server, wherein the first wallet user, the first wallet server, the second wallet user, and the second wallet server are registered with the directory server, and a plurality of details associated with the first and the second wallet users and the first and the second wallet servers is stored in a database associated with the directory server; sending, by the directory server to the first wallet server, one or more details among the plurality of details associated with the second wallet server and the second wallet user in response to the request message, wherein the first wallet server generates a transaction message comprising at least the one or more details; receiving, by the directory server, the transaction message and appending transaction details; and sending, by the directory server, the transaction message to the second wallet server for completing the transaction between the first wallet server and the second wallet server.

Clause 2: The method of clause 1, wherein the plurality of details is stored in the database in a tokenized manner after successful registration of the first and the second wallet users and the first and the second wallet servers with the directory server.

Clause 3: The method of clause 1 or 2, wherein the plurality of details comprises at least one of the following: a plurality of first wallet server identities, a plurality of second wallet server identities, a plurality of first wallet user aliases, a plurality of second wallet user aliases, a first wallet server name, a second wallet server name, a first wallet username, a second wallet username, first wallet user contact details, second wallet user contact details, or any combination thereof.

Clause 4: The method of any of clauses 1-3, wherein the one or more details comprises at least one of a second wallet server identification and a second wallet user alias, wherein at least the second wallet server identification is included in the transaction message.

Clause 5: The method of any of clauses 1-4, wherein the one or more details are tokenized before sending to the first wallet server.

Clause 6: The method of any of clauses 1-5, further comprising verifying compliance of the transaction message with one or more business rules.

Clause 7: The method of any of clauses 1-6, wherein the one or more business rules comprise validating the transaction message for Anti-Money Laundering (AML) compliance based at least partially on verifying historical data associated with the first and the second wallet users.

Clause 8: The method of any of clauses 1-7, wherein the one or more business rules comprise validating the transaction message for Know Your Customer (KYC) compliance based at least partially on verifying at least information associated with the first and the second wallet users and the first and the second wallet servers, and the plurality of details.

Clause 9: The method of any of clauses 1-8, wherein the one or more business rules are used to determine a chargeback and representment for the transaction.

Clause 10: The method of any of clauses 1-9, wherein the transaction details comprise at least one of the following: a type of transaction, a first wallet server identification, a first wallet server name, a second wallet server identification, a second wallet server name, a first wallet user alias, a second wallet user alias, transaction amount, transaction date, transaction time, transaction location, transaction currency, or any combination thereof.

Clause 11: The method of any of clauses 1-10, wherein the transaction message is generated according to ISO 8583 standard and ISO 20022 standard.

Clause 12: A directory server, comprising: one or more processors; and one or more computer-readable media, communicatively coupled to the one or more processors and storing instructions, which upon execution causes the processor to: receive a request message from a first wallet server for initiating a transaction from a first wallet user associated with the first wallet server to a second wallet user associated with a second wallet server, wherein the first wallet user, the first wallet server, the second wallet user, and the second wallet server are registered with the directory server, and a plurality of details associated with the first and the second wallet users and the first and the second wallet servers is stored in a database associated with the directory server; send, to the first wallet server, one or more details among the plurality of details associated with the second wallet server and the second wallet user in response to the request message, wherein the first wallet server generates a transaction message comprising at least the one or more details; receive the transaction message and appending transaction details; and send the transaction message to the second wallet server for completing the transaction between the first wallet server and the second wallet server.

Clause 13: The directory server of clause 12, wherein the one or more processors are configured to store the plurality of details in the database in a tokenized manner after successful registration of the first and the second wallet users and the first and the second wallet servers with the directory server.

Clause 14: The directory server of clause 12 or 13, wherein the one or more processors are configured to verify compliance of the transaction message with one or more business rules for at least one of the following: validating the transaction message for Anti-Money Laundering (AML) compliance based at least on verifying historical data associated with the first and the second wallet users; validating the transaction message for Know Your Customer (KYC) compliance based at least on verifying at least information associated with the first and the second wallet users and the first and the second wallet servers, and the plurality of details; or any combination thereof.

Clause 15: The directory server of any of clauses 12-14, wherein the one or more processors use the one or more business rules to determine a chargeback and representment for the transaction.

Clause 16: A computer-implemented method comprising: receiving, by a directory server, a plurality of registration details related to a plurality of wallet servers and respective wallet users for registering with the directory server; authenticating, by the directory server, the plurality of registration details of the plurality of wallet servers and respective wallet users based on a plurality of parameters; creating, by the directory server, an identity for each wallet server and an alias for each respective wallet user; and tokenizing, by the directory server, the plurality of registration details for storing the plurality of details and a plurality of tokens corresponding to the plurality of details in a database associated with the directory server, wherein a first wallet server initiated a transaction between a first wallet user associated with the first wallet server and a second wallet user associated with a second wallet server, wherein the first wallet server generates a transaction message comprising at least one or more details associated with the first and the second wallet users and the first and the second wallet servers are stored in a database associated with the directory server, wherein the directory server receives the transaction message and appends transaction details in the transaction message and sends the transaction message to the second wallet server for completing a wallet-to-wallet transfer.

Clause 17: The method of clause 16, wherein the plurality of registration details comprises at least one of the following: name and address of the plurality of wallet servers, name and address of the respective wallet users, Know Your Customer (KYC) details associated with the wallet customer, currency enabled in the plurality of wallet servers, currency preferred by the wallet users, or any combination thereof.

Clause 18: The method of clause 16 or 17, wherein the plurality of parameters comprises at least one of the following: a risk score associated with the plurality of wallet servers and/or the wallet users, transactions patterns associated with the wallet servers and/or the wallet users, chargeback patterns associated with the wallet users, representment history associated with the wallet users, transaction success rate associated with the wallet servers, or any combination thereof.

Clause 19: The method of any of clauses 16-18, further comprising determining Anti-Money Laundering (AML) activity of at least one of the plurality of wallet servers or respective wallet users based on the plurality of parameters and one or more business rules.

Clause 20: The method of any of clauses 16-19, further comprising at least one of the following: validating the transaction message for Anti-Money Laundering (AML) compliance based at least on verifying historical data associated with the first and the second wallet users; validating the transaction message for Know Your Customer (KYC) compliance based at least on verifying information associated with the first and the second wallet users and the first and the second wallet servers, and the plurality of details; or any combination thereof.

In some non-limiting embodiments or aspects, a computer-implemented method for performing inter wallet transactions is disclosed. The method comprises receiving a request message from a first wallet server for initiating a transaction from a first wallet user associated with the first wallet server to a second wallet user associated with a second wallet server, where the first wallet user, the first wallet server, the second wallet user, and the second wallet server were registered with the directory server and a plurality of details associated with the first and the second wallet users and the first and the second wallet servers is stored in a database associated with the directory server. The method further comprises sending one or more details among the plurality of details associated with the second wallet server and the second wallet user in response to the request message, where the first wallet server generates a transaction message comprising at least the one or more details. The method further comprises receiving the transaction message and appending transaction details. Furthermore, the method comprises sending the transaction message to the second wallet server for completing the transaction between the first wallet server and the second wallet server.

In some non-limiting embodiments or aspects, a directory server is disclosed. The directory server is configured to facilitate inter wallet transactions. The directory server comprises one or more processors and one or more computer-readable media communicatively coupled with the one or more processors. The one or more processors are configured to receive a request message from a first wallet server for initiating a transaction from a first wallet user associated with the first wallet server to a second wallet user associated with a second wallet server, wherein the first wallet user, the first wallet server, the second wallet user, and the second wallet server were registered with the directory server and a plurality of details associated with the first and the second wallet users and the first and the second wallet servers is stored in a database associated with the directory server. The one or more processors are further configured to send to the first wallet server one or more details among the plurality of details associated with the second wallet server and the second wallet user in response to the request message, wherein the first wallet server generates a transaction message comprising at least the one or more details. The one or more processors are further configured to receive the transaction message and appending transaction details. Thereafter, the one or more processors are configured to send the transaction message to the second wallet server for completing the transaction between the first wallet server and the second wallet server.

In some non-limiting embodiments or aspects, a computer-implemented method for performing inter wallet transactions is disclosed. The method comprises receiving a plurality of registration details related to a plurality of wallet servers and respective wallet users for registering with a directory server. The method comprises authenticating the plurality of registration details of the plurality of wallet servers and respective wallet users based on a plurality of parameters. The method comprises creating an identifier (ID) for each wallet server and an alias for each of respective wallet user after authenticating. Thereafter, the method comprises tokenizing the plurality of registration details for storing the plurality of details and a plurality of tokens corresponding to the plurality of details in a database associated with the directory server, where a first wallet server initiated a transaction between a first wallet user associated with the first wallet server and a second wallet user associated with a second wallet server. The first wallet server generates a transaction message comprising at least one or more details associated with the first and the second wallet users and the first and the second wallet servers are stored in a database associated with the directory server. The directory server receives the transaction message and appends transaction details in the transaction message and sends the transaction message to the second wallet server for completing wallet-to-wallet transfer.

The foregoing summary is illustrative only and is not intended to be in any way limiting. In addition to the illustrative aspects, embodiments, and features described above, further aspects, embodiments, and features may become apparent by reference to the drawings and the following detailed description. Additional features and advantages are realized through the techniques of the present disclosure. Other embodiments and aspects of the disclosure are described in detail herein and are considered a part of the claimed disclosure.

### BRIEF DESCRIPTION OF THE DRAWINGS

The novel features and characteristic of the disclosure are set forth in the appended claims. The disclosure itself, however, as well as a preferred mode of use, further objectives and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 illustrates an exemplary platform for performing inter wallet transactions, in accordance with an embodiment of the present disclosure;

FIG. 2 illustrates an exemplary core system architecture of implementing inter wallet transactions, in accordance with an embodiment of the present disclosure;

FIGS. 3A and 3B illustrate an exemplary mobile application for initiating an inter wallet transaction, in accordance with an embodiment of the present disclosure;

FIGS. 4A and 4B illustrate an exemplary transaction check-out page provisioning an inter wallet transaction, in accordance with an embodiment of the present disclosure;

FIG. 5 is a flowchart describing registration of a wallet and a wallet user for performing inter wallet transactions, in accordance with an embodiment of the present disclosure;

FIG. 6 is a flowchart describing inter wallet transactions, in accordance with an embodiment of the present disclosure;

FIG. 7 illustrates an exemplary flow of messages sent during inter wallet transactions, in accordance with an embodiment of the present disclosure;

FIG. 8 illustrates an exemplary user interface of a recipient wallet, in accordance with an embodiment of the present disclosure; and

FIG. 9 illustrates a general-purpose computer system for enabling inter wallet transactions, in accordance with one embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown. While each of the figures illustrates a particular embodiment for purposes of illustrating a clear example, other embodiments may omit, add to, reorder, and/or modify any of the elements shown in the figures.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, a specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has”, “have”, “having”, or the like are intended to be open-ended terms. Further, the phrase “based on” is intended to mean “based at least in partially on” unless explicitly stated otherwise. The term “some non-limiting embodiments or aspects” means “one or more (but not all) embodiments or aspects of the disclosure(s)” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

As used herein, the terms “communication”, “communicate”, “send”, and/or “receive” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “server” and/or “processor” may refer to one or more computing devices, such as processors, storage devices, and/or similar computer components that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as, but not limited to, processors, servers, client devices, software applications, and/or other like components. In addition, reference to “a server” or “a processor”, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Typically, electronic wallets or mobile wallets or digital wallets (also referred as wallets throughout this disclosure) are used to perform transactions at various merchant sites. A wallet may be an electronic medium associated with a banking institute for performing transactions. In some non-limiting embodiments or aspects, the wallet may be associated with one or more banking institute. In some non-limiting embodiments or aspects, the wallet may comprise details related to one or more cards associated with a customer. In some non-limiting embodiments or aspects, the wallet may facilitate transactions between a merchant and one or more banking institute. In some non-limiting embodiments or aspects, the wallet may provision storing of amount in the wallet and the amount may be used during transactions.

Currently, a plurality of wallets is available and each merchant is associated with one or more wallets among the plurality of wallets. A customer associated with a wallet can transact at a merchant site using any of the one or more wallets associated with the merchant. For example, if a merchant “M” is associated with two wallets “W1” and “W2”, a customer can use the any of the wallets “W1” or “W2” to transact at the merchant site, provided the customer is registered in either of the wallets “W1” or “W2”. Due to abundance of wallet providers, a merchant may provide few wallet options for making payment. In such situations, the customer may have to use other payment methods, such as credit cards or cash. There does not exist a platform for making transactions between wallets. Thus, inter wallet transactions is helpful when limited wallet options are provided and an amount has to be transferred from one wallet to another wallet.

Non-limiting embodiments or aspects of the present disclosure relate to methods and systems for performing inter wallet transactions. The present disclosure provides method and a system for enabling inter wallet transactions. A plurality of wallet servers is associated with a plurality of wallet users. Each wallet server will have registered respective wallet users by performing, for example, Know Your Customer (KYC) validations. A directory server may act as a network between a plurality of wallets. In some non-limiting embodiments or aspects, the directory server receives a request message from a first wallet server for initiating a transaction from a first wallet user to a second wallet user associated with a second wallet server. In some non-limiting embodiments or aspects, the directory server sends one or more details among a plurality of details associated with the second wallet server and the second wallet user to the first wallet server in response to the request message. Further, in some non-limiting embodiments or aspects, the directory server receives a transaction message from the first wallet server and appends transaction details to the transaction message. Thereafter, the directory server may send the appended transaction message to the second wallet server for completing the transaction between the first wallet server and the second wallet server.

In non-limiting embodiments or aspects of the present disclosure, an inter wallet transaction is useful in a scenario when a first user has to transfer an amount to a second user. Wallets are very helpful for their ease of usage and the security provided. For example, a user has registered with two wallet servers (102 and 104). During shopping, merchants accept wallet payment as generally wallets provide offers. There may be instances where the user has run out of balance in the wallet providing the offer. In such situation, there can exist a need to recharge the wallet. One way of recharging the wallet is to transfer from another wallet. However, current wallets do not provide such an option. The present disclosure is applicable in such scenarios where a transaction can be made between wallets.

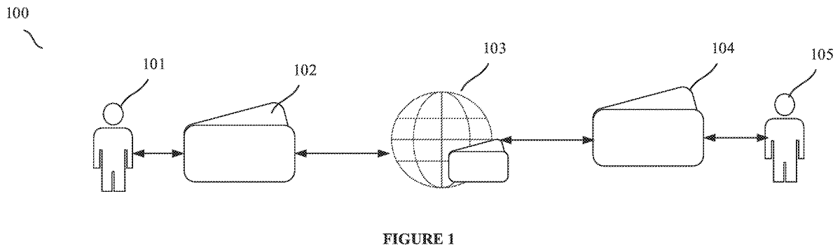

FIG. 1 is directed to a non-limiting embodiment or aspect of a platform (100) for performing inter wallet transactions. The platform (100) is provided as a service to a plurality of wallet servers (102, 104), and wallet users (101, 105). The description herein of inter wallet payment transactions covers the payment transaction and specific message flows. The present disclosure pertains to inter wallet transactions and/or electronic transactions using wallets.

The platform (100) is designed to facilitate transactions between a plurality of wallet servers (102, 104). For example, the platform (100) can be used in various transactions when a transaction is initiated between a first wallet server (102) and a second wallet server (104). When a transaction is initiated from a first wallet server (102) to a second wallet server (104), the first wallet server (102) is associated with an issuer server and the second wallet server (104) is associated with an acquirer server. In some non-limiting embodiments or aspects, the issuer server and the acquirer server may be referred to as sender and receiver, respectively, throughout this disclosure. In some non-limiting embodiments or aspects, the plurality of wallet servers (102 104) may not be associated with the third-party domain. In such scenarios, for a transfer between wallets, an amount is stored in the recipient wallet. In some non-limiting embodiments or aspects, the plurality of wallet servers (102, 104) is recharged using Internet banking or credit cards. A first wallet user (101) is registered with the issuer server and the second wallet user (105) is registered with the acquirer server. In some non-limiting embodiments or aspects, each wallet is associated with a plurality of issuer servers and a plurality of acquirer servers. In one embodiment in a wallet-to-wallet transaction, the wallet servers (102, 104) or issuer/acquirer server may accept legal responsibility for the authentication of the wallet users (101, 105).

In wallet-to-wallet transactions, a flow of a transaction begins with a first wallet user (101) initiating a transaction in an electronic device. The first wallet user (101) may enter recipient details such as second wallet server name and second wallet username and/or a number in the electronic device. A directory server (103) facilitates the transaction between the first wallet server (102) and the second wallet server (104).

The first wallet server (102) receives inputs from the first wallet user (101) and requests the directory server (103) to facilitate the transaction by providing the second wallet server and user details and first wallet server and user details. In some non-limiting embodiments or aspects, the first wallet server and the user (102 and 101) and the second wallet server and the user (104 and 105) are registered with the directory server (103). In some non-limiting embodiments or aspects, the directory server (103) validates the wallet server and users based upon Know Your Customer (KYC) compliance and other parameters, e.g., validity of wallet, validity of wallet user, type of transaction allowed, location of transaction allowed, amount allowed, inter wallet allowed between first and second wallets, and the like. In some non-limiting embodiments or aspects, the KYC compliance is validated by determining details associated with the first and the second wallet servers (102, 104) and the first and second wallet users (101, 105). KYC compliance may be performed using existing methodology.

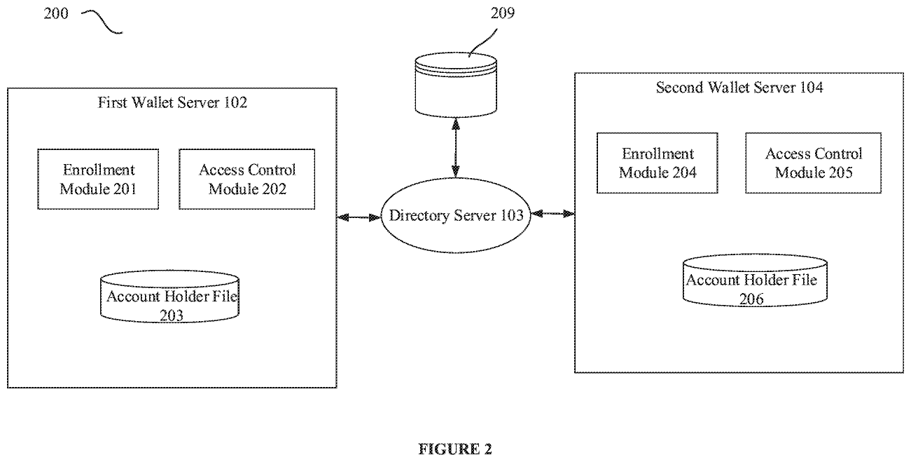

FIG. 2 illustrates a non-limiting embodiment or aspect of a core system architecture (200) of the platform (100). The core system architecture (200) includes at least the first wallet server (102), the directory server (103), and a second wallet server (104). In some non-limiting embodiments or aspects, the wallet servers may register the wallet users based on respective KYC compliance rules and other parameters, e.g., validity of wallet, validity of wallet user, type of transaction allowed, location of transaction allowed, amount allowed, inter wallet allowed between first and second wallet, and the like. Also, wallet servers may have association of a plurality of trusted parties. For example, the trusted parties may be institutions that provide an account to the user for making transactions. In some non-limiting embodiments or aspects, the trusted party from which a transaction is debited is denoted as issuer server and the trusted party to which a transaction is credited is denoted as acquirer server. In some non-limiting embodiments or aspects, the liability of authentication and authorization of a transaction may lie with the trusted parties or the wallet servers (102, 104).

The first wallet server (102) and the second wallet server (104) may each include an enrollment module (201, 204), an Access Control Module (ACM) (202, 205), and/or an account holder file (203, 206). In some non-limiting embodiments or aspects, the enrollment module (201, 204) is a computing unit, for example, a computer that manages a wallet user's enrollment into wallet server (102, 104) by presenting a series of questions (for example via a web interface) to be answered by the user and verified by the trusted party. As shown in FIG. 2, the wallet server (102, 104) operates the enrollment module (201, 204). However, in some non-limiting embodiments or aspects, a service organization, such as Visa®, can operate the enrollment module (201, 204) on behalf of the wallet server (102, 104). The wallet server (102, 104) can use a web-enabled, interactive “identity authentication service” provided by an outside entity during the enrollment process to help validate an account holder's identity. In some non-limiting embodiments or aspects, the wallet servers (102, 104) may verify the wallet user details with respective trusted party servers. For example, if a wallet user (101) has to enroll into the wallet server (102) and the wallet user (101) is associated with a bank institution, the wallet server (102) may verify the user details with the bank institution before enrolling the wallet user (101).

In some non-limiting embodiments or aspects, ACM (202, 205) is a computer that has a database of account holders registered for the account authentication service. The ACM (202, 205) includes account and password information for each account holder. During a wallet transaction, the ACM (202, 205) may receive or provide digitally signed receipts from the trusted parties. For example, considering a transaction between a first wallet server (102) and the second wallet server (104), the ACM (202) may access the issuer server for receiving a receipt of authentication and/or authorization from the issuer server. Once the first wallet server (102) receives the receipt of authentication and/or authorization, the transaction is initiated by debiting an amount by the issuer server from a first user account. At the second wallet server (104) end, once the transaction message is received, the ACM (205) may credit the received amount to the acquirer server which in turn credits the amount to a second user account associated for the recipient user.

In some non-limiting embodiments or aspects, account holder file (203, 206) is a wallet managed database for storing information relating to the account holders who are successfully enrolled with the wallet servers (102, 104). The directory server may be supported by the Internet, and includes components used by the plurality of wallet servers (102, 104). The directory server (103) is configured to route the transactions received from the first wallet server (102) to the second wallet server (104). The directory server (103) is operated by a card scheme manager or a service organization, such as a transaction service provider.

In some non-limiting embodiments or aspects, the directory server (103) is associated with a Common Directory of Aliases (CDA) database (209). In some non- limiting embodiments or aspects, the CDA (209) may be hosted in the directory server (103) or in a dedicated CDA server (not shown in FIG. 2). The CDA database (209) comprises unique identification (ID) and aliases for each wallet server and each wallet user. In some non-limiting embodiments or aspects, the unique ID of each wallet server may be similar to Bank Identification Number (BIN) or a cryptographically generated unique token/key. In some non-limiting embodiments or aspects, each wallet user is provided with an alias. The alias is used as a security feature to represent the wallet username. In some non-limiting embodiments or aspects, a plurality of details of a plurality of wallet servers (102, 104) and a plurality of wallet users (101, 105) are stored in the CDA database (209) in a tokenized manner. In an exemplary embodiment, JSON Web Token (JWT) standard tokens are generated. A person skilled in the art will appreciate that any technique can be employed for generating tokens and the present disclosure is not limited to generating tokens using JWT standard alone.

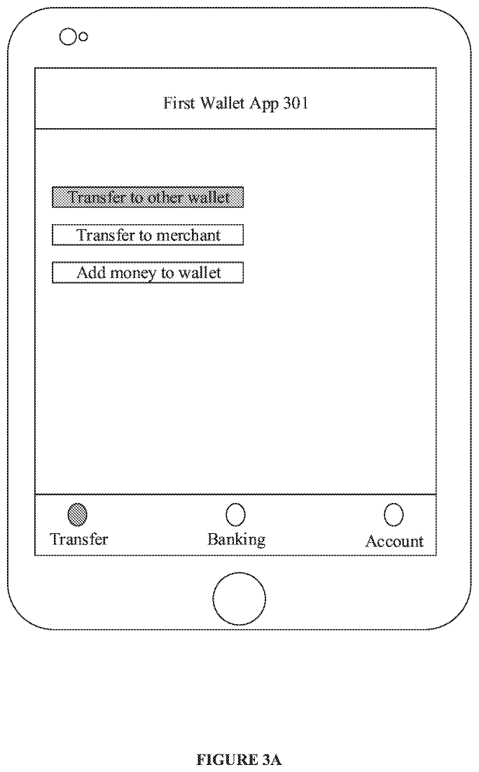

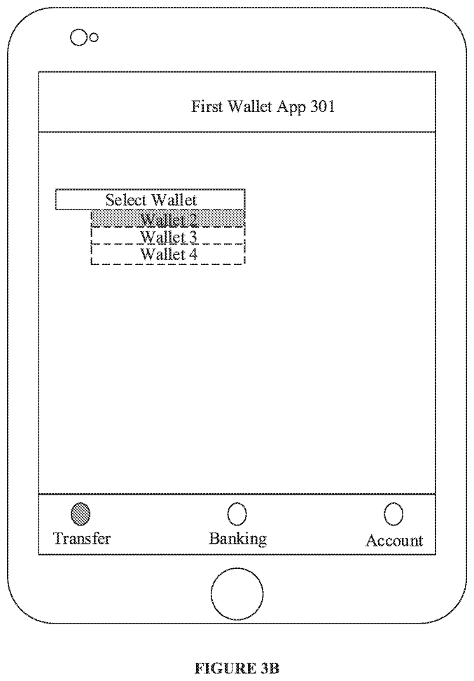

FIGS. 3A and 3B illustrate a non-limiting embodiment or aspect of a first wallet application (301). As shown, the first wallet application (301) is an application for making payments at merchant checkout pages in online transactions and merchant payment terminals in offline transactions. In some non-limiting embodiments or aspects, the first wallet application (301) is associated with the first wallet server (102). In some non-limiting embodiments or aspects, the first wallet user (101) can enroll into the first wallet server (102) using the first wallet application (301). For example, the enrollment module (201) may provide the questionnaire on the first wallet application (301). The first wallet user (101) may fill the questionnaire to enroll into the first wallet server (102). FIG. 3A shows a first application page where the first wallet application (301) may provide an option for making different types of transactions. As shown, and in some non-limiting embodiments or aspects, the first wallet application (301) can be used to make payments to merchants, transact with other wallets, or recharge the wallet. Upon selecting the option to transfer to wallet, a second page is loaded as shown in FIG. 3B.

FIG. 3B shows a second application page displaying different wallets associated with the first wallet server (102). In some non-limiting embodiments or aspects, the association between a plurality of wallets and the first wallet server (102) may be predefined. In some non-limiting embodiments or aspects, the association between the first wallet server (102) and the plurality of wallets may also depend on the directory server (103). In some non-limiting embodiments or aspects, the directory server (103) should facilitate a transaction between the first wallet server (102) and the plurality of wallets. In some non-limiting embodiments or aspects, the first wallet server (102) may be associated with different directory servers. For example, a first directory server may facilitate transactions between the first wallet server (102) and a first set of wallets. A second directory server (not shown) may facilitate transactions between the first wallet server (102) and a second set of wallets.

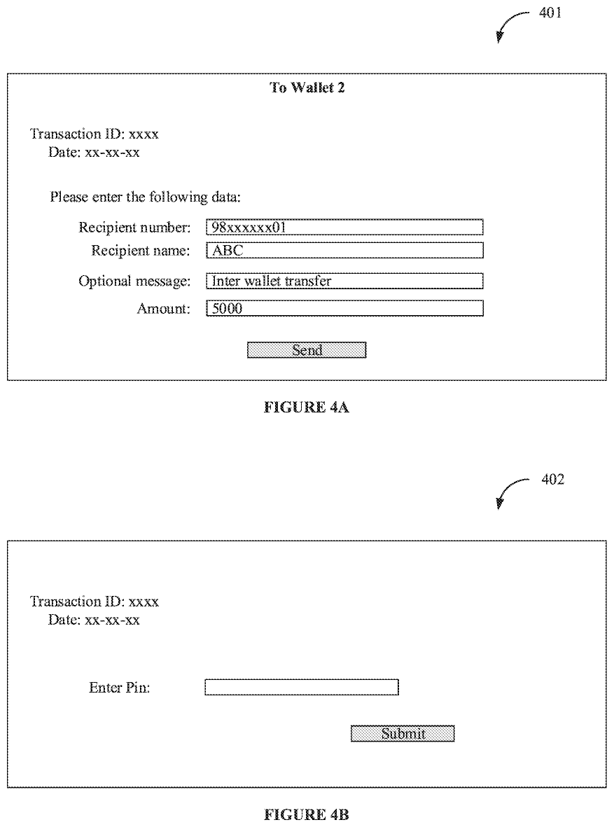

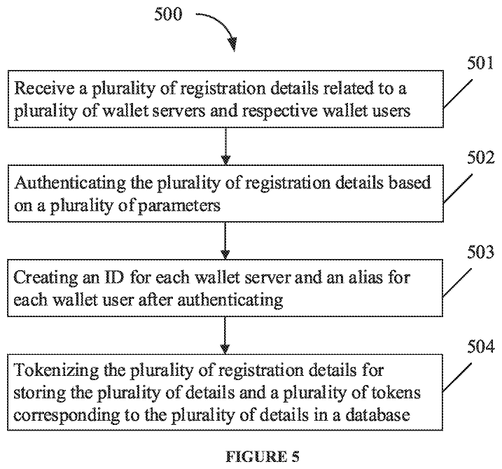

FIGS. 4A and 4B illustrate a non-limiting embodiment or aspect of a check-out page in the first wallet application (301). FIG. 4A illustrates an exemplary checkout page requesting recipient wallet and user details. The illustration in FIGS. 4A and 4B should not be construed as limiting, and the illustration is only an example and aspects described in FIGS. 4A and 4B can be applied to any checkout page. As shown, the checkout page comprises check-out details including amount and date. In some non-limiting embodiments or aspects, the checkout page can also include recipient wallet details and other necessary details pertaining to the transaction. As shown in FIG. 4A, a first form (401) requests the first wallet user (101) to enter details such as name of the recipient, number of the recipient, optional message, and amount for transfer. When the first wallet user (101) enters the details, the first wallet server (102) can identify the directory server (103) (such as Visa®) associated with the selected wallet. After entering the recipient wallet and user details, the checkout page may provide an option to select a source for debiting the amount. In some non-limiting embodiments or aspects, the transaction amount may be debited from the first wallet server (102) or an issuer server associated with the first wallet user (101). Thereafter, an authentication page as shown in FIG. 4B is provided to the first wallet user (101). Existing checkout pages offer authentication types including One Time Password (OTP) or static password or any other authentication methods. In some non-limiting embodiments or aspects, a static password may be a 3-D secure password. In some non-limiting embodiments or aspects, the 3-D secure password may be a static password set by a user. The static password may include at least a character, a numerical, and/or a special character. For example, the 3-D secure password may be “AbcD12@$xbvy”. In accordance with the present disclosure, the checkout page can provide any authentication means. For example, the Personal Identification Number (PIN) may be validated by the first wallet server (102) or the PIN may be validated by the issuer server. In case of Unified Payment Interface (UPI) based transactions, the PIN may be verified by the issuer server. In case of a typical wallet transaction, the wallet server may verify the pin.

In some non-limiting embodiments or aspects, the pin can be an OTP. In a further embodiment, the OTP is a numeric password (e.g., “148261”). In some non-limiting embodiments or aspects, the OTP can also be an alphanumeric password (e.g., “Pass123”). In an alternate embodiment, the OTP can also include special characters (e.g., “I”, “@”, “%”, and the like). In an exemplary embodiment, the OTP can have 4-8 digits and/or characters. In some non-limiting embodiments or aspects, the number of digits and/or characters in OTP can be according to standards followed by the issuer server. In some non-limiting embodiments or aspects, the OTP is copied to the clipboard after being generated. The copied OTP can be pasted in appropriate authentication forms.

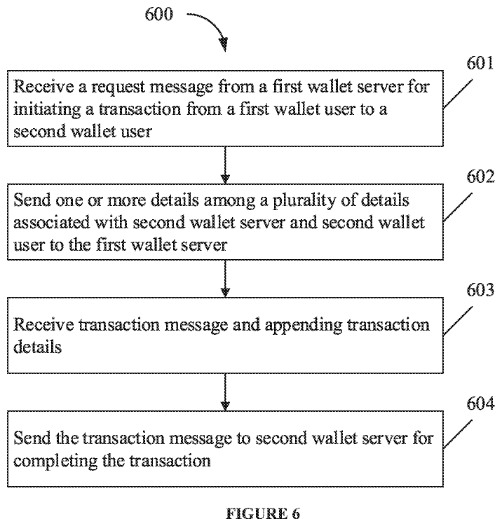

The following method describes the steps performed by the directory server (103). FIG. 5 is a flowchart describing registration of a plurality of wallet servers and a plurality of wallet users with the directory server (103), in accordance with a non-limiting embodiment or aspect of the present disclosure.

As illustrated in FIG. 5, the method (500) may comprise one or more steps. The method (500) may be described in the general context of computer executable instructions. Generally, computer executable instructions can include routines, programs, objects, components, data structures, procedures, modules, and functions, which perform particular functions or implement particular abstract data types.

The order in which the method (500) is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step (501), the directory server (103) receives a plurality of registration details related to a plurality of wallet servers and respective wallet users. In some non-limiting embodiments or aspects, the plurality of wallet servers and the plurality of wallet users have to register with the directory server (103). In some non-limiting embodiments or aspects, the registration is initiated at the wallet server end. In some non-limiting embodiments or aspects, a web-based application or a mobile-based application may be provided to each wallet server for registering with the directory server (103). In some non-limiting embodiments or aspects, each wallet server registers itself by providing the plurality of registration details related to respective wallet servers. In some non-limiting embodiments or aspects, the plurality of wallet servers and respective wallet users may register with the CDA server hosting the CDA database (209). In some non-limiting embodiments or aspects, the directory server stores all the details in the CDA database (209) in a tokenized manner.

In some non-limiting embodiments or aspects, the directory server (103) authenticates the plurality of details provided by each wallet server. The plurality of details can include, but is not limited to, wallet name, wallet office address, name and contact persons of wallet, KYC details, country of using the wallet, currency supported by the wallet, maximum transaction limit, minimum transaction limit, supported wallets, settlement entity details, and the like. In some non-limiting embodiments or aspects, the plurality of details related to wallet users may be provided by the wallet servers. The wallet servers may have stored the plurality of details related to the respective wallet users during user registration with the wallet. The plurality of details related to the wallet users may include, but is not limited to, wallet username, wallet user address, KYC details, unique ID, such as social security number, or the like.

At step (502), the directory server (103) authenticates the plurality of details related to the plurality of wallets and respective wallet users. In some non-limiting embodiments or aspects, the directory server (103) authenticates registration of the plurality of wallets and respective wallet users based on the plurality of parameters. The plurality of parameters can include, but is not limited to, a risk score associated with the plurality of wallet servers and the respective wallet users, transaction patterns associated with the plurality of wallet servers and respective wallet users, chargeback patterns and re-presentment history associated with the wallet users, and a transaction success rate associated with the plurality of wallet servers. In some non-limiting embodiments or aspects, the directory server (103) may request transaction history (e.g., two months transaction history) during registration. The transaction history may be used to determine transaction patterns, transaction success rate, blacklisted recipients, blacklisted users, suspicious transactions, and the like. Based on the determination, the directory server (103) authenticates registration of the plurality of wallets and respective wallet users.

At step (503), the directory server creates a unique ID (UID) for each wallet server and a unique alias for respective wallet users. The UID may be used in the transaction message to indicate the wallet servers involved in a transaction. Further, the directory server (103) creates a unique alias for each wallet user. In some non-limiting embodiments or aspects, the alias can be a random string and each alias is mapped to a wallet user. In some non-limiting embodiments or aspects, the alias can comprise a combination of characters and numbers. For example, the first wallet user alias may be “abcd” and the second wallet user alias may be “wxyz”. In an exemplary embodiment, the alias can include the UID of the corresponding wallet server. Thus, the mapping between the wallet user and corresponding wallet server is represented in the alias.

At step (504), the directory server (103) tokenizes the UID and the alias of each wallet server and respective wallet user before saving the UID and the alias in the CDA database (209). The tokens may be generated, for example, in JWT standard. Tokenizing the information provides security. In some non-limiting embodiments or aspects, during a transaction, the tokens are included in the transaction message. Thus, the wallet name or wallet username is not disclosed anywhere during a transaction. An example of an alias generation request and response to the alias generation request is shown below:

### Sample CreateAliases Request Fields

<Wallet Provider UID>
<Date/Time>
<Wallet User Name>
<Wallet User Phone/Email>
<Any Other Details related to Wallet User>

### Sample CreateAliases Response Fields

<Wallet Provider UID>
<Date/Time>
<Wallet User Alias>
<Status—Success/Failure>

In some non-limiting embodiments or aspects, the directory server (103) determines Anti-Money Laundering (AML) by at least one or more plurality of wallet servers based on the plurality of parameters and one or more business rules. In an embodiment, the one or more business rules includes, but is not limited to, validating the transaction message for AML compliance based at least on verifying historical data associated with the wallet users, where the one or more business rules comprise validating the transaction message for KYC compliance based at least on verifying at least information associated with the first and second wallet users and the first and the second wallet servers, and the plurality of details.

In some non-limiting embodiments or aspects, the UID and wallet user aliases are provided to respective wallet servers. In some non-limiting embodiments or aspects, the registration details can be updated. For example, wallet user details can be updated, wallet transaction limits can be updated, and the like. In some non-limiting embodiments or aspects, the alias and UID can be resolved to identify corresponding wallet server and wallet user.

As illustrated in FIG. 6, the method (600) may comprise one or more steps. The method (600) may be described in the general context of computer executable instructions. Generally, computer executable instructions can include routines, programs, objects, components, data structures, procedures, modules, and functions, which perform particular functions or implement particular abstract data types.

The order in which the method (600) is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step (601), the directory server receives a request message form the first wallet server (102) for initiating a transaction from the first wallet user (101) to the second wallet user (105) associated with the second wallet server (104). In some non-limiting embodiments or aspects, the request message is generated by the first wallet server (102) when the first wallet user (101) initiates a request for transacting with the second wallet user (105) associated with the second wallet server (104) as illustrated in FIG. 3A, FIG. 3B, FIG. 4A, and FIG. 4B. In some non-limiting embodiments or aspects, directory server (103) determines if the first wallet server (102), the first wallet user (101), the second wallet server (104), and the second wallet user (105) are registered with the directory server (103). In some non-limiting embodiments or aspects, the request message comprises first wallet server UID, wallet server BIN, date and time, settlement entity details, country in which transaction is initiated, currency of transaction, transaction amount, first wallet user alias, second wallet name, second wallet username, and any other detail required for completing the inter wallet transaction. The first wallet server (102) requests for the second wallet UID and second wallet user alias from the directory server (103).

At step (602), the directory server (103) sends one or more details among the plurality of details related to the wallet servers and the wallet users to the first wallet server (102). The directory server (103) retrieves the second wallet server UID and second wallet user alias from the CDA database (209) if the second wallet server (104) and the second wallet user (105) are already registered with the directory server (103). The directory server (103) sends the second wallet server UID, second wallet user alias, and a message related to successful creation of UID and alias to the first wallet server (102) in response to the request message. In an embodiment, the message can be a “success” or “failure”. In case of a failure message, the directory server (103) may not conclude the transaction. One reason for a failure message can be unregistered wallet and wallet user. Another reason can be blacklisted wallet and/ or wallet user. In some non-limiting embodiments or aspects, the one or more details are tokenized before sending to the first wallet server (102).

In some non-limiting embodiments or aspects, upon receiving the one or more details, the first wallet server (102) generates a transaction message comprising at least the one or more details. In an exemplary embodiment, the first wallet server (103) may generate the transaction message according to ISO 8583 or ISO 20022 standard. In some non-limiting embodiments or aspects, at least the one or more details in the transaction message may be included in ISO 8583 Field 2 and additional fields such as F104, etc. A person skilled in the art should not construe this as a limitation and should appreciate that any available field in the ISO 8583 messaging format can be utilized for generating the transaction message for inter wallet transactions.

At step (603), the directory server (103) receives the transaction message from the first wallet server (102) and appending transaction details in the transaction message. In some non-limiting embodiments or aspects, the transaction details include one or more of the following: type of transaction, a first wallet server ID, a first wallet server name, a second wallet server ID, a second wallet server name, a first wallet user alias, a second wallet user alias, transaction amount, date, time, location, currency of transaction, or any combination thereof. In some non-limiting embodiments or aspects, the transaction message received from the first wallet server (102) may include fewer details such as the first wallet UID, first wallet user alias, second wallet server UID, second wallet user alias, transaction amount, date and time, location, and such details in an untokenized manner. The directory server (103) tokenizes the transaction details present in the transaction message and may also append additional details related to the transaction such as unique code indicating inter wallet transfer, currency exchange data, and the like in the transaction message. In some non-limiting embodiments or aspects, the directory server (103) may regenerate the appended transaction message and the details of the appended transaction message may be included in ISO 8583 Field 104. A person skilled in the art should not construe this as a limitation and should appreciate that any available field in the ISO 8583 messaging format can be utilized for generating the transaction message for inter wallet transactions. Accordingly, any available fields in ISO 20022 may be utilized for including the transaction details. An example of the appended transaction message is given below:

| | |
|---|---|
| 104.# DS ID—Related Tran Data | 57 |
| 104.# Dataset Length | <<>> |
| 104.# BAI—Inter Wallet Transfer | IW |
| 104.# DSI—Sender Tokenized Data | YY |
| 104.# Dataset Length | <<>> |
| 104.# Sender Wallet Provider Name | Google Pay |
| 104.# Sender Wallet Ref Number | ajdjgu944k9kk |
| 104.# Sender Alias Name | abcd |
| 104.# Receiver Alias Name | wxyz |

At step (604), and in some non-limiting embodiments or aspects, the directory server (103) performs various checks before sending the transaction message to the second wallet server (104) for completing the inter wallet transaction. The various checks can include identity check, KYC status check, risk score check, blacklisted wallets and user check, and the like. In some non-limiting embodiments or aspects, the identity check comprises authenticating the identity of the first and second wallet server (102, 104) and the first and second wallet user (101, 105). In some non-limiting embodiments or aspects, the KYC status check comprises determining KYC compliance of the first and the second wallet server (102, 104) and the first and second wallet user (101, 105). KYC compliance may be performed using existing techniques. In some non-limiting embodiments or aspects, the directory server (103) determines a risk score for the first and second wallet server (102, 104) and the first and second wallet user (101, 105). In some non-limiting embodiments or aspects, the risk score can be calculated using a plurality of parameters including but not limited to number of failed transactions, transactions to blacklisted wallets and users, frequent chargebacks, and the like. In some non-limiting embodiments or aspects, risk calculating techniques can be employed to determine the risk score. The above factors can make up one or more business rules for determining AML. AML is detected by the directory server (103) and such detection can be used to blacklist wallet servers or wallet users. In some non-limiting embodiments or aspects, the AML detection can be shared with the plurality of wallet servers so that the plurality of wallet servers can also take appropriate measures against such AML detection.

In some non-limiting embodiments or aspects, the directory server (103) enables chargebacks and representment in inter wallet transactions. A chargeback is provided to a wallet user associated with a wallet server when an unauthorized transaction or erroneous transaction occurs. In some non-limiting embodiments or aspects, the wallet user may request for a chargeback using the wallet application. The wallet server receives the chargeback request from the wallet application and thereafter requests the directory server (103) to provide chargeback to the wallet server. For example, considering a transaction has occurred between the first wallet server (102) and the second wallet server (104). When the first wallet user (101) requests for a chargeback, the chargeback request is forwarded to the directory server (103). In some non-limiting embodiments or aspects, the directory server (103) may validate the chargeback request. In some non-limiting embodiments or aspects, the recipient server (second wallet server (104) in this example) may validate the chargeback request. Once the chargeback request is validated, the chargeback is initiated, and the amount debited for the first wallet user (101) is credited back. In some non-limiting embodiments or aspects, the chargeback request is validated based on historical chargeback requests.

In some non-limiting embodiments or aspects, the directory server (103) enables representment for the chargeback provided. A representment of a chargeback is a dispute against the chargeback provided. For example, consider a transaction from a first entity to a second entity. The first entity has requested for chargeback for the transaction. The second entity may request for a representment by disputing the chargeback requested by the first entity. In some non-limiting embodiments or aspects, sufficient data may be collected by the recipient wallet server to request for representment. Upon validating a representment request, the directory server (103) may initiate the representment for the chargeback. Additionally, the directory server (103) stores details of historical original transactions in the database (209) that can help to identify whether the original transaction was performed successfully. Thereby, chargeback can be initiated (if original was not performed/not successful) or a following representment (if original was success) and chargeback is at fault.

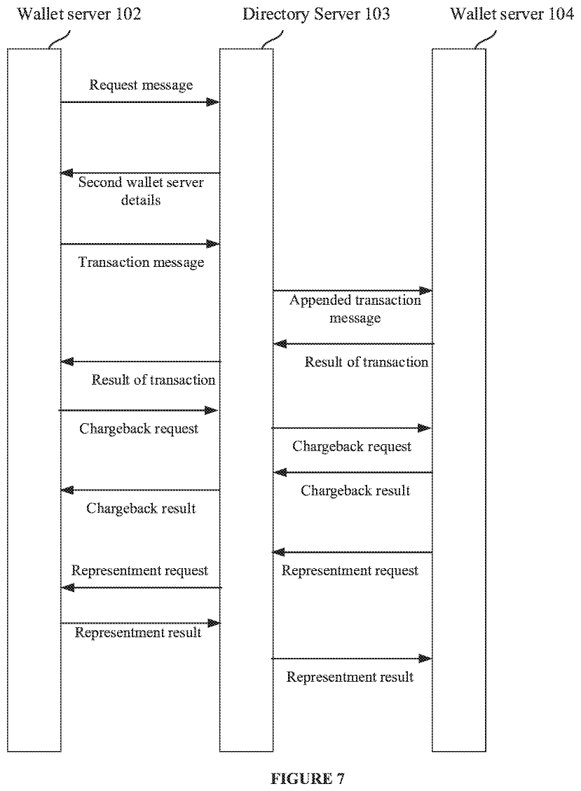

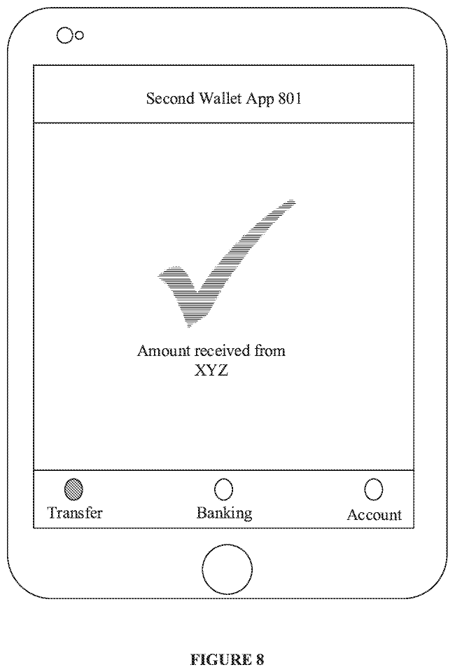

FIG. 7 illustrates a flow of messages in an inter wallet transaction. Considering a transaction between the first wallet server (102) and the second wallet server (104), the first wallet server (102) sends a request message to the directory server (103) for initiating a transaction from the first wallet server (102) to the second wallet server (104). Further, the directory server (103) receives the request message and sends second wallet user details to the first wallet server (102). Thereafter, the first wallet server (102) provides the second wallet server (104) and second wallet user (105) details to the first wallet server (102). The first wallet server (102) generates the transaction message comprising the transaction details and transmits the transaction message to the directory server (103). The directory server (103) appends the transaction message and transmits the appended transaction message to the second wallet server (104) for completing the transaction. Further, the second wallet server (104) may generate a result of transaction message and the directory server (103) may forward the result of the transaction message to the first wallet server (102). FIG. 7 also illustrates message flow in a case of chargebacks and representment. As shown, the chargeback is requested by the first wallet server (102) which is debited. The chargeback request is sent to the directory server (103) and the directory server (103) forwards the chargeback request to the second wallet server (104). The second wallet server (104) validates the chargeback request and provides a chargeback result. The chargeback result can be one of a success or a failure. The chargeback result is forwarded to the first wallet server (102). Likewise, the representment request is generated against the chargeback (if second wallet provider thinks the chargeback is wrong and original was a success) by the second wallet server (104) and is forwarded to the first wallet server (102) via the directory server (103). The first wallet server (102) validates the representment request and provides a representment result. The representment result can be one of a success or a failure. The representment result is forwarded to the second wallet server (104).

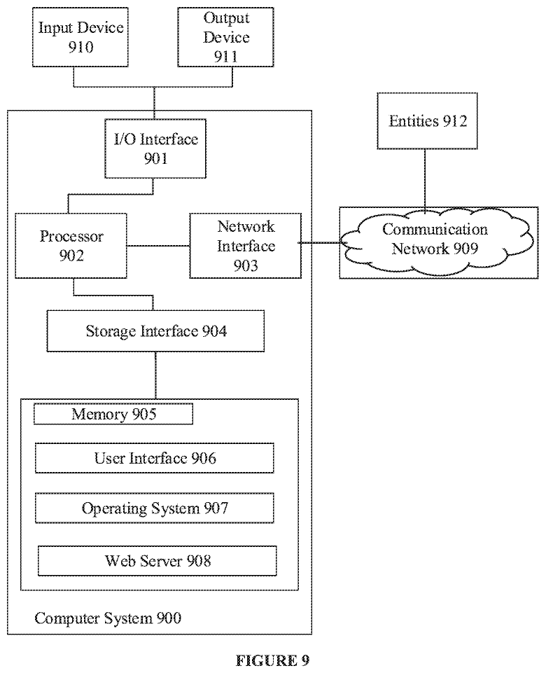

FIG. 8 illustrates a non-limiting embodiment or aspect of a second wallet application (801). The second wallet application (801) is associated with the second wallet server (104). The second wallet application (801) may indicate the second wallet user (105) once the transaction is complete and the wallet is credited with the transacted amount. In some non-limiting embodiments or aspects, the second wallet application (801) may also show notifications related to chargeback and representment. In some non-limiting embodiments or aspects, the present disclosure discloses methods and a system for enabling inter wallet transactions. In some non-limiting embodiments or aspects, chargebacks and representment are facilitated in inter wallet transactions.

FIG. 9 illustrates a block diagram of an exemplary computer system (900) for implementing embodiments consistent with the present disclosure. In some non-limiting embodiments or aspects, the computer system (900) is used to implement the method for performing an inter wallet transaction. In some non-limiting embodiments or aspects, the computer system (900) may implement the functionalities of the directory server (103). The computer system (900) may comprise a central processing unit (“CPU” or “processor”) (902). The processor (902) may comprise at least one data processor for executing program components for dynamic resource allocation at run time. The processor (902) may include specialized processing units such as integrated system (bus) controllers, memory management control units, floating point units, graphics processing units, digital signal processing units, etc.

The processor (902) may be disposed in communication with one or more input/output (I/O) devices (not shown) via I/O interface (901). The I/O interface (901) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax®, or the like), etc.

Using the I/O interface (901), the computer system (900) may communicate with one or more I/O devices. For example, the input device (910) may be an antenna, keyboard, mouse, joystick, (infrared) remote control, camera, card reader, fax machine, dangle, biometric reader, microphone, touch screen, touchpad, trackball, stylus, scanner, storage device, transceiver, video device/source, etc. The output device (911) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some non-limiting embodiments or aspects, the computer system (900) is connected to the service operator through a communication network (909). The processor (902) may be disposed in communication with the communication network (909) via a network interface (903). The network interface (903) may communicate with the communication network (909). The network interface (903) may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network (909) may include, without limitation, a direct interconnection, e-commerce network, a peer to peer (P2P) network, local area network (LAN), wide area network (WAN), wireless network (e.g., using Wireless Application Protocol), the Internet, Wi-Fi®, etc. Using the network interface (903) and the communication network (909), the computer system (900) may communicate with the one or more service operators.

In some non-limiting embodiments or aspects, the processor (902) may be disposed in communication with a memory (905) (e.g., RAM, ROM, etc. not shown in FIG. 9) via a storage interface (904). The storage interface (904) may connect to memory (905) including, without limitation, memory drives, removable disc drives, etc., employing connection protocols such as serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (905) may store a collection of program or database components including, without limitation, user interface (906), an operating system (907), a web server (908), etc. In some non-limiting embodiments or aspects, the computer system (900) may store user/application data, such as the data, variables, records, etc. as described in this disclosure. Such databases may be implemented as fault-tolerant, relational, scalable, secure databases such as Oracle or Sybase.

The operating system (907) may facilitate resource management and operation of the computer system (900). Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, 10 etc.), Apple iOS, Google Android, Blackberry OS, or the like.

In some non-limiting embodiments or aspects, the computer system (900) may implement a web browser (not shown) stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, Adobe® Flash®, JavaScript®, Java®, Application Programming Interfaces (APIs), etc. In some non-limiting embodiments or aspects, the computer system (900) may implement a mail server stored program component. In some non-limiting embodiments or aspects, the web server (908) may act as a mail server as well. The mail server may be an Internet mail server such as Microsoft® Exchange, or the like. The mail server may utilize facilities such as ASP, ActiveX, ANSI C++/C#, Microsoft® .NET, CGI scripts, Java®, JavaScript®, PERL, PHP, Python, WebObjects, etc. The mail server may utilize communication protocols such as Internet Message Access Protocol (IMAP), Messaging Application Programming Interface (MAPI), Microsoft® Exchange, Post Office Protocol (POP), Simple Mail Transfer Protocol (SMTP), or the like. In some non-limiting embodiments or aspects, the computer system (900) may implement a mail client stored program component. The mail client may be a mail viewing application, such as Apple® Mail, Microsoft® Entourage®, Microsoft® Outlook®, Mozilla® Thunderbird®, etc.

In some non-limiting embodiments or aspects, the computer system (900) is a directory server providing services for facilitating transactions between a merchant associated with an acquirer system and an issuer system. In some non-limiting embodiments or aspects, the computer system (900) is connected to the entities comprising the merchant, acquirer system, and issuer system.

In some non-limiting embodiments or aspects, the entities (912) may be several systems connected to the computer system (900) in facilitating the inter wallet transaction.

The terms “some non-limiting embodiments or aspects”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having”, and variations thereof mean “including but not limited to”, unless expressly specified otherwise.

The enumerated listing of items does not imply that any or all of the items are mutually exclusive, unless expressly specified otherwise. The terms “a”, “an”, and “the” mean “one or more”, unless expressly specified otherwise.

A description of an embodiment with several components in communication with each other does not imply that all such components are required. On the contrary a variety of optional components is described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIGS. 5 and 6 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A computer-implemented method, comprising:
receiving, by a directory server, a request message from a first wallet server for initiating a transaction from a first wallet user associated with the first wallet server to a second wallet user associated with a second wallet server, wherein the first wallet user, the first wallet server, the second wallet user, and the second wallet server are registered with the directory server, and a plurality of details associated with the first and the second wallet users and the first and the second wallet servers is stored in a database associated with the directory server;
sending, by the directory server to the first wallet server, one or more details among the plurality of details associated with the second wallet server and the second wallet user in response to the request message, wherein the first wallet server generates a transaction message comprising at least the one or more details;
receiving, by the directory server, the transaction message and appending transaction details; and
sending, by the directory server, the transaction message to the second wallet server for completing the transaction between the first wallet server and the second wallet server.

2. The method of claim 1, wherein the plurality of details is stored in the database in a tokenized manner after successful registration of the first and the second wallet users and the first and the second wallet servers with the directory server.

3. The method of claim 1, wherein the plurality of details comprises at least one of the following: a plurality of first wallet server identities, a plurality of second wallet server identities, a plurality of first wallet user aliases, a plurality of second wallet user aliases, a first wallet server name, a second wallet server name, a first wallet username, a second wallet username, first wallet user contact details, second wallet user contact details, or any combination thereof.

4. The method of claim 1, wherein the one or more details comprises at least one of a second wallet server identification and a second wallet user alias, wherein at least the second wallet server identification is included in the transaction message.

5. The method of claim 1, wherein the one or more details are tokenized before sending to the first wallet server.

6. The method of claim 1, further comprising verifying compliance of the transaction message with one or more business rules.

7. The method of claim 6, wherein the one or more business rules comprise validating the transaction message for Anti-Money Laundering (AML) compliance based at least partially on verifying historical data associated with the first and second wallet users.

8. The method of claim 6, wherein the one or more business rules comprise validating the transaction message for Know Your Customer (KYC) compliance based at least partially on verifying at least information associated with the first and the second wallet users and the first and the second wallet servers, and the plurality of details.

9. The method of claim 6, wherein the one or more business rules are used to determine a chargeback and representment for the transaction.

10. The method of claim 1, wherein the transaction details comprise at least one of the following: a type of transaction, a first wallet server identification, a first wallet server name, a second wallet server identification, a second wallet server name, a first wallet user alias, a second wallet user alias, transaction amount, transaction date, transaction time, transaction location, transaction currency, or any combination thereof.

11. The method of claim 1, wherein the transaction message is generated according to ISO 8583 standard and ISO 20022 standard.

12. A directory server, comprising:
one or more processors; and
one or more computer-readable media, communicatively coupled to the one or more processors and storing instructions, which upon execution causes the processor to:
receive a request message from a first wallet server for initiating a transaction from a first wallet user associated with the first wallet server to a second wallet user associated with a second wallet server, wherein the first wallet user, the first wallet server, the second wallet user, and the second wallet server are registered with the directory server, and a plurality of details associated with the first and the second wallet users and the first and the second wallet servers is stored in a database associated with the directory server;
send, to the first wallet server, one or more details among the plurality of details associated with the second wallet server and the second wallet user in response to the request message, wherein the first wallet server generates a transaction message comprising at least the one or more details;
receive the transaction message and appending transaction details; and
send the transaction message to the second wallet server for completing the transaction between the first wallet server and the second wallet server.

13. The directory server of claim 12, wherein the one or more processors are configured to store the plurality of details in the database in a tokenized manner after successful registration of the first and the second wallet users and the first and the second wallet servers with the directory server.

14. The directory server of claim 12, wherein the one or more processors are configured to verify compliance of the transaction message with one or more business rules for at least one of the following: validating the transaction message for Anti-Money Laundering (AML) compliance based at least on verifying historical data associated with the first and the second wallet users; validating the transaction message for Know Your Customer (KYC) compliance based at least on verifying at least information associated with the first and the second wallet users and the first and the second wallet servers, and the plurality of details; or any combination thereof.

15. The directory server of claim 14, wherein the one or more processors use the one or more business rules to determine a chargeback and representment for the transaction.

16. A computer-implemented method comprising:
receiving, by a directory server, a plurality of registration details related to a plurality of wallet servers and respective wallet users for registering with the directory server;
authenticating, by the directory server, the plurality of registration details of the plurality of wallet servers and respective wallet users based on a plurality of parameters;
creating, by the directory server, an identity for each wallet server and an alias for each respective wallet user; and
tokenizing, by the directory server, the plurality of registration details for storing the plurality of details and a plurality of tokens corresponding to the plurality of details in a database associated with the directory server, wherein a first wallet server initiated a transaction between a first wallet user associated with the first wallet server and a second wallet user associated with a second wallet server, wherein the first wallet server generates a transaction message comprising at least one or more details associated with the first and the second wallet users and the first and the second wallet servers are stored in a database associated with the directory server, wherein the directory server receives the transaction message and appends transaction details in the transaction message and sends the transaction message to the second wallet server for completing a wallet-to-wallet transfer.

17. The method of claim 16, wherein the plurality of registration details comprises at least one of the following: name and address of the plurality of wallet servers, name and address of the respective wallet users, Know Your Customer (KYC) details associated with the wallet customer, currency enabled in the plurality of wallet servers, currency preferred by the wallet users, or any combination thereof.

18. The method of claim 16, wherein the plurality of parameters comprises at least one of the following: a risk score associated with the plurality of wallet servers and/or the wallet users, transactions patterns associated with the wallet servers and/or the wallet users, chargeback patterns associated with the wallet users, representment history associated with the wallet users, transaction success rate associated with the wallet servers, or any combination thereof.

19. The method of claim 16, further comprising determining Anti-Money Laundering (AML) activity of at least one of the plurality of wallet servers or respective wallet users based on the plurality of parameters and one or more business rules.

20. The method of claim 19, further comprising at least one of the following: validating the transaction message for Anti-Money Laundering (AML) compliance based at least on verifying historical data associated with the first and the second wallet users; validating the transaction message for Know Your Customer (KYC) compliance based at least on verifying information associated with the first and the second wallet users and the first and the second wallet servers, and the plurality of details; or any combination thereof.
